(19) United States
(12) Patent Application Publication
(10) Pub. No.: US 2006/0031988 A1
(43) Pub. Date: Feb. 16, 2006

(54) Tube and wire clip for hospital bed

(76) Inventor: Michael G. Morse, Brookeville, MD (US)

Correspondence Address: RICHARD L HUFF, 19304 OLNEY MILL ROAD, OLNEY, MD, 20832, US

(21) Appl. No.: 11/202,237

(22) Filed: Aug. 12, 2005

Related U.S. Application Data
(60) Provisional application No. 60/600,769, filed on Aug. 12, 2004.

(51) Int. Cl. A61G 7/05

(52) U.S. Cl. 5/600; 280/304; 5/658; 5/503.1

(57) ABSTRACT

A holder which is attachable to hospital beds for keeping wires and tubes from falling down between the mattress and the railing and from becoming entangled. The holder contains a means for attaching the holder to a bed rail. The holder also contains one or more hooks. An adjustable holder also contains a base portion, a first arcuate section containing a raised handle at the top and catches in the upper-right section. The holder also contains a second arcuate section and a release tab.

### CROSS-REFERENCE TO RELATED APPLICATIONS

This application claims the benefit of applicants provisional application, Ser. No. 60/600,769, filed Aug. 12, 2004.

### STATEMENT REGARDING FEDERALLY SPONSORED RESEARCH OR DEVELOPMENT

(Not applicable)

### REFERENCE TO SEQUENTIAL LISTING, A TABLE, OR A COMPUTER PROGRAM LISTING APPENDIX SUBMITTED ON A COMPACT DISC

(Not applicable)

### BACKGROUND OF THE INVENTION

1) Field of the invention

This invention is directed to devices intended to hold tubes and wires associated with patient care and comfort. The tubes do not get tangled and remain readily accessible to both the patient and medical staff.

2) Description of the related art

The prior art is aware of devices intended to hold tubes and wires so that they are safely out of the way when associated with hospital beds. Thus, U.S. Pat. No. 5,334,186 issued to Alexander Aug. 2, 1994 discloses a plate having holes for tubes and wires. The plate is held to the bedrail by straps.

U.S. Pat. No. 5,336,179 issued to Ryan Aug. 9, 1994 discloses a flat plate having slots for holding tubes and wires. The plate is held to the bedrail by straps.

For devices having holes, the tubes and wires must either be threaded through the holes, which is difficult and disturbing to the patient or, as shown by the '186 patent, all of the holes must be opened in order to access a single hole. In devices holding a plurality of tubes and wires, this process can become awkward and the tubes can become intertwined.

### BRIEF SUMMARY OF THE INVENTION

A hospital patient may need a number of tubes and wires either readily accessible to the patient or inserted in the patient. A call button which has dropped to the floor or an intravenous tube which has become snagged can present potential hazards to the patient or be a source of aggravation to the patient.

This invention presents a device which attaches easily to the bedrails of a hospital bed and simply and effectively makes tubes and wires readily accessible to the patient and hospital staff while keeping the tubes and wires separated and free from the possibility of getting stuck between the bed arm and the mattress.

The device of this invention has a body which has a means on one side which allows attachment of the device to the bedrail. This means may be a strip of adhesive capable of adhering to the bedrail or it may be eye and hook fasteners on one side capable of fastening to corresponding eye and hook fasteners on a bedrail.

The opposing side of the body contains at least one hook which simply and effectively maintain tubes or wires together or separated from each other while still being readily accessible to the patient or staff.

There may be also at least one adjustable holder which allows for a more secure holding of a tube or wire. The adjustable holder contains a base having a first arcuate section, a second arcuate section, and a third upstanding part which is flexible and contains a catch. The first arcuate section makes up about 270° of a circle. It has a raised handle at the top and catches in the upper-right section. The second arcuate section takes up the remainder of a circle. The third upstanding part contains a catch which holds the catch of the first upstanding part in place. The two sets of catches are of the same size and shape so that when they are mated the two parts will not separate. The third upstanding part contains a release tab to allow for the easy separation of the first and third upstanding parts. Thus, this invention provides a simple, inexpensive device capable of keeping tubes and wires separated in a hospital bed environment.

### BRIEF DESCRIPTION OF THE SEVERAL VIEWS OF THE DRAWINGS

FIG. 1 is a side elevational view of the device of this invention.

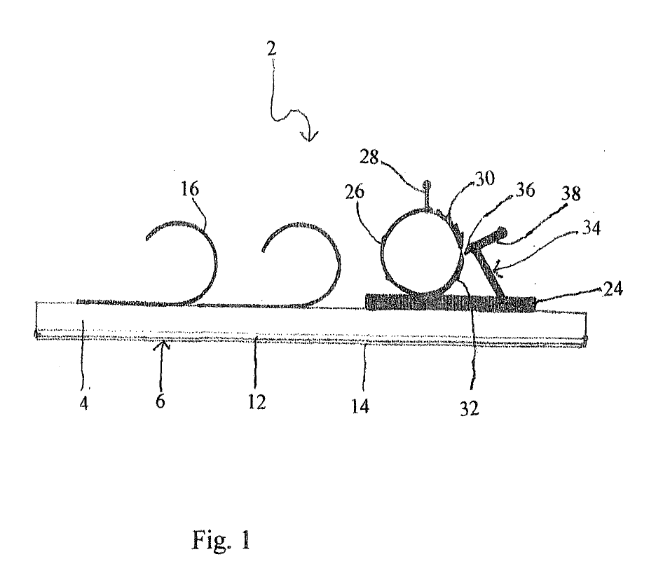

FIG. 2 is a side elevational view of the device of this invention on a bedrail with a tube and a wire passing through the device.

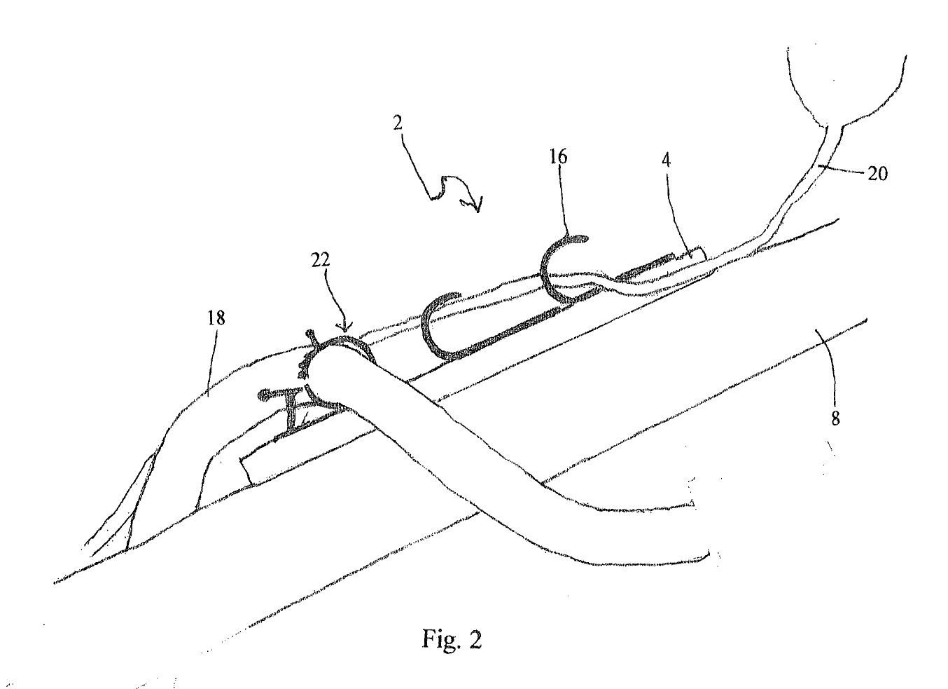

FIG. 3 is a perspective view of a hospital bed having the device of this invention mounted on a bedrail.

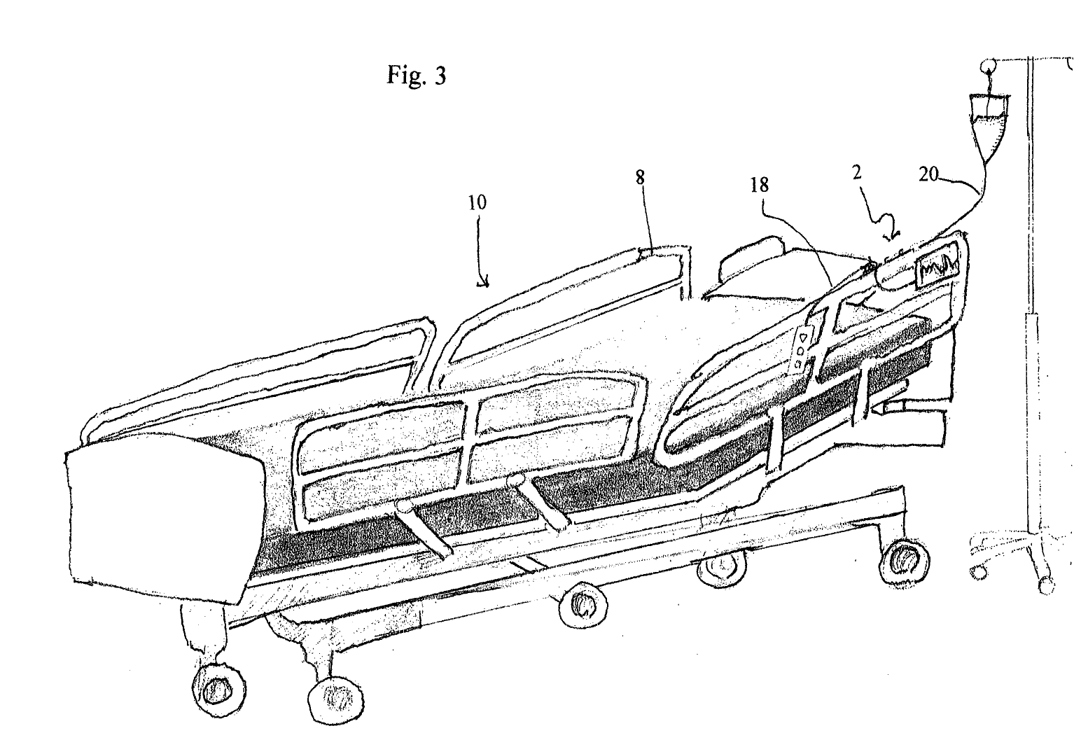

### DETAILED DESCRIPTION OF THE INVENTION

The present invention seeks to solve the problem of tubes and wires associated with a hospital bed which are just out of reach, are tangled, or are caught between the bedrail and the mattress.

The device 2 contains an elongated body 4. The body 4 is preferably made of plastic.

On the first side of the body 4 there is attached a means 6 which allows detachable attachment of the device 2 to bedrails 8 of hospital beds 10. Such a means 6 may be eye and hook fasteners such as Velcro®. These fasteners will attach to corresponding hook and eye fasteners on the bedrail 8. Preferably, the means 6 is a tape 12 with adhesive backing originally covered by a cover 14 which can be peeled off. In less preferred embodiments, the body 4 may be taped or tied to the bedrail 8. The means 6 allows the device 2 to be securely held to a bedrail 8, yet be easily removed with hand pressure when so desired.

On the second, opposing side of the body 4 are hooks 16 to keep wires 18 or tubes 20 separated from each other while being accessible to the patient and hospital staff. Each hook 16 is cantilevered, arises from the body 4 and has a free end spaced apart from the body 4. A tube 20 or wire 18 may simply be placed in the space between the hook 16 and the body 4 and thus held separately from other tubes 20 or wires 18 in the hospital bed 10 environment.

To more securely hold a tube 20 or wire 18, the device 2 of this invention provides at least one adjustable holder 22. In the preferred method of manufacture, the body 4, the hooks 16, and the adjustable holder 22 are co-molded by injection molding and are made as a single piece of plastic. Each adjustable holder 22 constitutes a base portion 24, a first arcuate section 26 containing a raised handle 28 at the top thereof and catches 30 in the upper-right section thereof, a second raised arcuate section 32 which is separated from the first raised arcuate section 26, and a release tab 34.

The outside surface of the first arcuate section 26 contains a plurality of catches 30. The release tab 34 contains a single catch 36 which is of the same size and shape as the catches 30 of the first arcuate section 26. To hold a wire 18 or a tube 20, the user uses finger force on the handle 28 to separate the first 26 and second 32 arcuate sections, inserts the wire 18 or tube 20 in the space in the adjustable holder 22, and uses finger force on the handle 28 to push the catches 30 of the first arcuate section 26 between the second arcuate section 32 and the single catch 36 of the release tab 34. The natural tendency of the first arcuate section 26 to return to its original position forces the catches 30 of the first arcuate section 26 to mate with the catch 36 of the release tab 34 in such a way that the first arcuate section 26 is firmly held between the second arcuate section 32 and the release tab 34. Outward pressure will not separate the catches 30, 36. However, light outward or downward pressure on the handle 38 of the release tab 34 will allow the separation of the catches 30, 36.

I claim

1. A device for holding tubes and wires associated with hospital beds, said device comprising a body, at least one hook for maintaining wires and tubes so that they will not become entangled, and one adjustable holder, the adjustable holder comprising a base having a first arcuate section, a second arcuate section, and an upstanding section which is flexible and contains a catch.

2. The device of claim 1, wherein the body contains a means for attaching the device to a bedrail.

3. The device of claim 2, wherein the first arcuate section makes up about 270 degrees of a circle.

4. The device of claim 3, wherein the first arcuate section has an upper right-hand section and contains a handle and catches in this upper right-hand section.

5. The device of claim 1 in combination with a bedrail of a hospital bed.
